(19) United States
(12) Patent Application Publication
(10) Pub. No.: US 2014/0337185 A1
(43) Pub. Date: Nov. 13, 2014

(54) SYSTEM AND METHOD FOR DISPLAYING A RETAILER INTERFACE

(71) Applicant: PICK'NTELL LTD., Tel Aviv (IL)

(72) Inventor: Asaf LEWIN, Nordiya (IL)

(73) Assignee: PICK'NTELL LTD., Tel Aviv (IL)

(21) Appl. No.: 13/888,381

(22) Filed: May 7, 2013

(51) Int. Cl. G06Q 30/06; G06Q 30/02

(52) U.S. Cl. CPC G06Q 30/0641; G06Q 30/0257
USPC 705/27.1; 235/375

(57) ABSTRACT

The subject matter discloses a method performed on a server, comprising receiving a retailer interface information from a retailer, said retailer interface information comprises features selection information and layout selection information of the retailer; generating a retailer interface from the retailer interface information; detecting an event between a mobile device and the retailer; responsive to detection of the event, receiving a request to download the retailer interface to be embedded in a mobile application of the mobile device; and, transmitting the retailer interface to the mobile device.

### FIELD OF THE INVENTION

The subject matter relates generally to system and method for displaying a retailer interface on a mobile device.

### BACKGROUND OF THE INVENTION

Mobile device displays are adaptive to display environments of a requesting application. This may include receiving a request from a requesting application, the request indicating a display environment of the requesting application and transforming the document from a first display style to a second display style, the second display style being associated with the display environment of the requesting application.

The mobile device may display advertisements on an application. The application determines one or more policies for presenting advertisement information at the application, the device, or a combination thereof. Processing of the one or more policies is then performed to determine advertisement information for presentation at the one or more applications, the device, or a combination thereof based, at least in part, on the one or more user interface state changes. A server captures a visit pattern of the customer at a physical location based on communication from the mobile device. A relevant marketing message, such as SMS or email message for the customer is determined based on the customer's presence, visit pattern, personal information, and location. The marketing message is delivered directly to a wireless device carried to the customer upon a subsequent entry of the customer to the business establishment.

### SUMMARY

It is an object of the subject matter to discloses a method performed on a server, comprising receiving a retailer interface information from a retailer, said retailer interface information comprises features selection information and layout selection information of the retailer; generating a retailer interface from the retailer interface information; detecting an event between a mobile device and the retailer; responsive to detection of the event, receiving a request to download the retailer interface to be embedded in a mobile application of the mobile device; transmitting the retailer interface to the mobile device.

In some cases, the event is the mobile device receiving a retailer code of the retailer.

In some cases, the request is sent upon detection of a retailer code.

In some cases, a retailer code is generated by the server and sent to the retailer.

In some cases, the method further comprises sending the mobile application to the mobile device for displaying the retailer interface.

In some cases, the mobile application is a same binary application.

In some cases, the same binary application comprises a different icon, a name, a description on the server according to parameters sent to the server through a download link and a combination thereof.

In some cases, the method further comprises the retailer interface updating when a mobile device accesses the retailer interface.

In some cases, the method further comprises generating two or more retailer codes for the retailer, each retailer code of the two or more retailer codes is provided to a different mobile device.

In some cases, the method further comprises generating two or more retailer codes for the retailer, at least two retailer codes of the two or more retailer codes are associated with different retailer interfaces.

In some cases, the features selection information comprises modules that are configured to be activated by the mobile device.

In some cases, the method further comprises storing a mobile device unique identification information and a IP address to identify the mobile device by the server.

In some cases, the method further comprises transmitting a download link to the retailer, wherein the download link is provided for the mobile device to access the retailer interface.

It is another object of the subject matter to disclose a method performed on a mobile device, comprising detecting a retailer code associated with a retailer; sending a request to a server to receive a retailer interface, said retailer interface corresponding to the retailer code; receiving the retailer interface from the server; displaying the retailer interface on the mobile device.

In some cases, the method further comprises receiving a mobile application to engage the retailer interface.

In some cases, the mobile application is configured to provides the mobile device with content associated with a plurality of retailers, wherein the content is associated with the retailer of the plurality of retailers according to the retailer code.

In some cases, the mobile application serves the plurality of retailers by providing the mobile device the content associated with the plurality of retailers according to data received from the server, wherein the mobile application displays the content associated with a single retailer of the plurality of retailers according to the retailer code.

In some cases, detecting the retailer code comprises obtaining an image of a retailer logo.

In some cases, detecting the retailer code comprises scanning a retailer QR code.

In some cases, the method further comprises selecting one retailer interface from two or more retailer interfaces.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a computerized environment for a mobile application, according to some exemplary embodiments of the subject matter;

FIG. 2 shows a mobile device having a mobile application for engaging a retailer interface, according to some exemplary embodiments of the subject matter;

FIG. 3 shows a method for generating a retailer interface on a server, according to some exemplary embodiments of the subject matter;

FIG. 4 shows a method performed on a mobile device for displaying a retailer interface, according to some exemplary embodiments of the subject matter; and,

FIG. 5A-5B shows a mobile device obtaining a retailer code and retailer interface, according to some exemplary embodiments of the subject matter.

### DETAILED DESCRIPTION

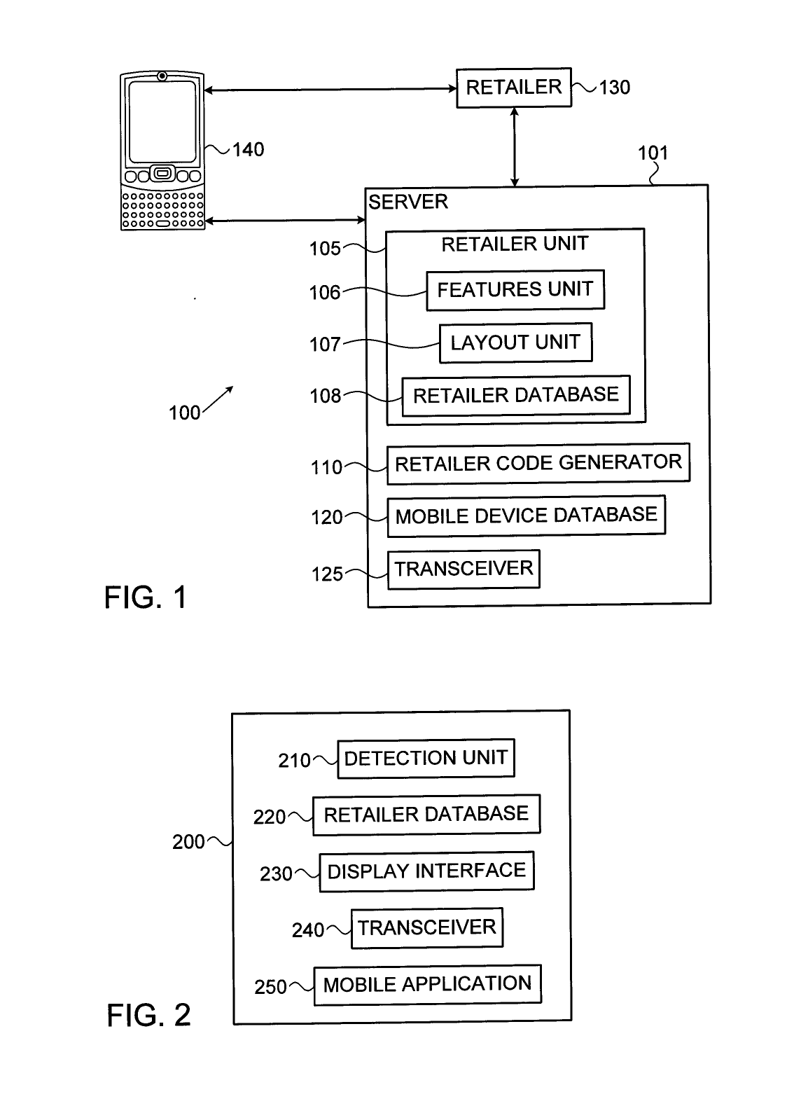

The subject matter discloses a system and method for displaying a retailer interface on a mobile device. FIG. 1 shows a computerized environment for a mobile application, according to some exemplary embodiments of the subject matter. The computerized environment 100 comprises a server 101. The server 101 comprises a retailer unit 105, which generates the retailer interface. The retailer unit 105 comprises a features unit 106 which is used to receive and store features selection information for creating elements of the retailer interface. The features selection information comprises modules, for example, sale coupons, discount offers, and the like. The retailer unit 105 comprises a layout unit 107, which is used to receive and store the layout selection information. The layout selection information comprises icons sets, fonts, custom colors, custom images, and the like. The retailer unit 105 comprises a retailer database 108, which stores the retailer interface and a retailer's information, such as name, business information, and the like. The server 101 comprises a retailer code generator 110, which generates a retailer code that is sent to a retailer 130 to enable a mobile device 140 to request the retailer information that corresponds to the retailer code. The retailer interface corresponds to the retailer code generated by the server 101. The retailer code generator 110 may generate the code in the form of a serial code, QR code, or the like, that the mobile device 140 scans to obtain the retail code. The retailer code may be positioned within the physical store of the retail, in the retailer's online store, or in printed or digital material, such that the mobile device 140 scans the code and receives a retailer interface from the server 101, according to a set of rules determined by the retailer unit 105. In some cases, the retailer code generator 110 may generate a download link that may be used by the mobile device 140 to request the retailer interface.

The retailer unit 105 may store data associated with a plurality of retailers, and send a retailer interface to the mobile device 140 according to a specific retailer associated with a retailer code scanned by the mobile device. In some exemplary cases, the code is compared to a plurality of codes, and then a retailer 130 is identified. In some exemplary cases, one retailer has a plurality of codes generated by the retailer code generator 110. For example, each code of the plurality of codes is associated with a different store of the retailer 130. In some other cases, each code of the plurality of codes is associated with a different mobile device. In some exemplary embodiments of the subject matter, the server 101 may generate two or more retailer codes for the retailer 130. Each retailer code of the two or more retailer codes corresponds to a different retailer interface. In some cases, at least two retailer codes of the two or more retailer codes are associated with different retailer interfaces.

The server 101 further comprises a transceiver 125, which sends the retailer code to the retailer 130. The transceiver 125, receives requests from the mobile device 140 for the retailer interface. The transceiver 125 sends the retailer interface to the mobile device 140, which is required to engage the retailer interface. In some cases, the transceiver 125 sends the mobile application to the mobile device 140. In some cases, the retailer code may be stored in the retailer database 108 with the retailer information. The server 101 comprises a mobile device database 120, which stores information about mobile devices, such as manager information, last used IP address of the mobile device 140, a device unique id, last geo-location of the mobile device, and the like. The server 101 uses the information about mobile devices to determine whether the mobile device 140 had previously received the mobile application. Where the mobile device 140 had not previously received the mobile application, the server 101 sends the mobile device 140 the mobile application and the retail interface upon detection of an event between the mobile device 140 and the retailer 130. The event may be direct communication between the mobile device 140 and an antenna stored inside the retailer store, RF ID signal, NFC scan, voice signal, geo-location of the retail store or any other event that can be linked to the retailer store. Where the mobile device 140 already comprises the mobile application the server 101 sends only the retailer interface. In some exemplary embodiments of the subject matter, the server 101 generates two or more retailer interfaces for one retailer. A unique retailer code is created for each retailer interface of the two or more retailer interfaces.

FIG. 2 shows a mobile device having a mobile application for engaging a retailer interface, according to some exemplary embodiments of the subject matter. The mobile device 200 comprises a detection unit 210, which detects a retailer code, for example by scanning the code or by receiving a wireless or voice signal from a transmitter located in the retailer's store or any other geo-presence method such as GPS, RF ID signal and NFC scan. The retailer code may be detected by the detection unit 210 by scanning a QR code, wireless receipt of the retailer code, downloading the retailer code from a website, or the like. The mobile device 200 may comprise a retailer database 220, which stores a plurality of retailer interfaces received by the mobile device 200. The mobile device 200 comprises a display interface 230, which displays the retailer interface selected from the plurality of retailer interfaces. The display interface 230 may display icons and interactive objects that enable a user of the mobile device 200 to interact with the retailer interface. For example, the display interface 230 displays a shoe store retailer interface, which comprises an icon for buying a pair of shoes. The user of the mobile device 200 may engage the icon by pressing on it on the display interface 230 in order to buy the pair of shoes. The mobile device 200 comprises a mobile application 250, which engages the retailer interface. The mobile application 250 is received from the server 101 of FIG. 1 and embedded into the mobile device 200. The mobile device 200 comprises a transceiver 240 for receiving the retailer interface. The transceiver 240 enables the mobile device 200 to receive the retailer interface, for example through WiFi communications. The transceiver also enables the mobile device 200 to transmit a notification to the server 101 that a retailer code has been detected by the mobile device 200. Upon such notification, the server 101 transmits the retailer interface to the mobile application 250 of the mobile device 200. In some exemplary embodiments of the subject matter, the mobile application 250 comprises a same binary application. The same binary application comprises a different icon, name, description on an application store, and the like, according to parameters sent to the server 101 of FIG. 1 through the download link. The mobile application 250 provides a plurality of retailers the opportunity to communicate with a single user of the mobile device 200, without requiring the user of the mobile device 200 to download many mobile applications, where each mobile application belongs to a different retailer of the plurality of retailers. The mobile application 250 provides the user of the mobile device 200 with content and interface that is relevant to a single retailer of the plurality of retailers upon receiving a request resulting from an event between the mobile device 200 and the specific retailer.

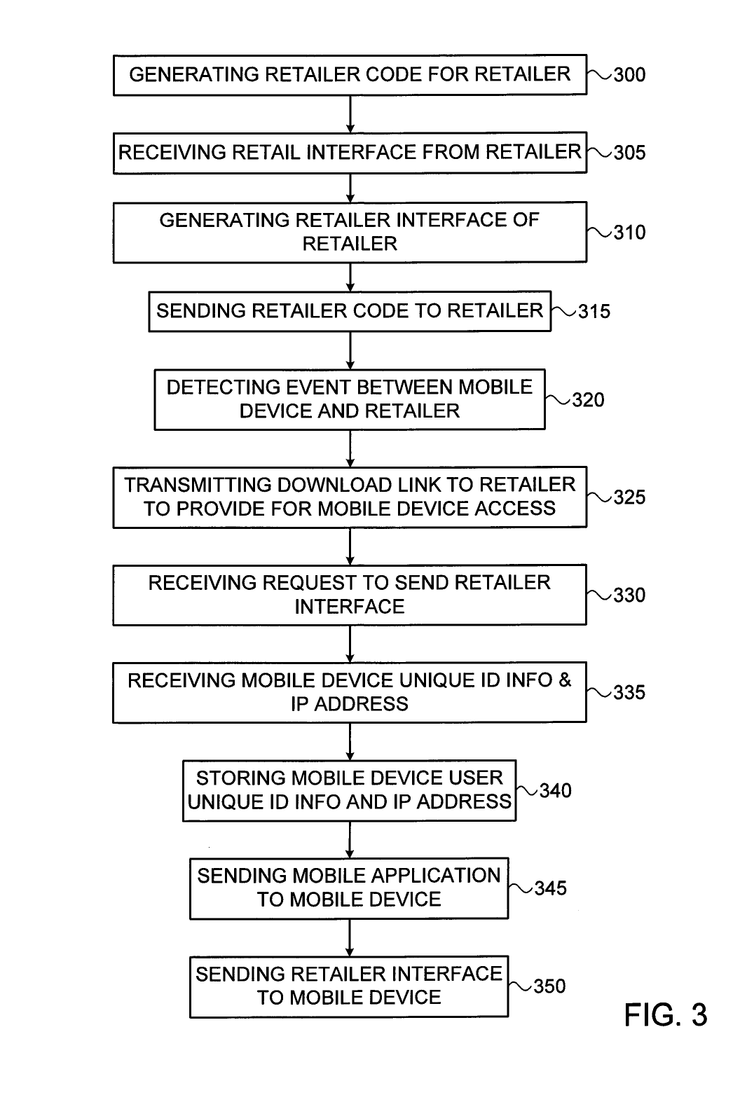

FIG. 3 shows a method for generating a retailer interface on a server, according to some exemplary embodiments of the subject matter. Step 300 discloses generating a retailer code for a retailer. The server 101 of FIG. 1 receives a request to generate a retailer interface for the retailer. The server 101 generates the retailer code that identifies the retailer interface. The retailer code may later be embedded in a download link on a retailer website or in other printed or digital material, embedded in a QR code, or the like. In some case, two or more retailer codes are generated for the retailer. Step 305 discloses receiving retail interface information from the retailer. The server 101 requests the retailer to provide the retail interface information that a retailer merchant wants. The retail interface information comprises features selection information and layout selection information from the retailer. The features selection information comprises modules, such as sale coupons, discount events, community features, and the like. The layout selection information may comprise icons sets, fonts, custom colors, custom images, and the like. Step 310 discloses generating the retailer interface. The retailer unit 105 of FIG. 1 generates the retailer interface using the retailer interface information received from the retailer.

Step 315 discloses sending the retailer the retail code. The server 101 sends the retailer code to the retailer via web interface, email or the like. The server 101 may send the retailer code as a serial code, QR code or the like, that is scanned by a user of the mobile device. The retailer code may be provided in the form of a download link that directs the mobile device to a link for requesting the retailer interface from the server 101. Step 320 discloses detecting an event between a mobile device and the retailer. The detection may occur by the server 101 receiving a message from the mobile device or from the retailer that the mobile device accessed the retailer code in order to obtain the retailer interface. For example, the server may receive a message from the mobile device that the mobile device scanned a retailer QR code. In another example, the server 101 may receive the message from the retailer informing the server 101 that the mobile device accessed the retail code through the download link available on a retailer website. The event may also be wireless communication between the mobile device and an antenna located in the physical business of the retailer or any other geo-presence method such as GPS, RF ID signal, NFC scan or the like. Step 325 discloses transmitting a download link of the mobile application to the mobile device. Such transmission of the download link may be performed responsive to detection of the event between the mobile device and the retailer, as disclosed in step 320.

Step 330 discloses receiving a request to send the retailer interface. The server 101 receives the request to send the retailer interface to the mobile device. Such request is received upon detection of the event as disclosed in step 320. Step 335 discloses receiving the mobile device unique identification information and IP address. The unique identification information comprises of information such as a mobile device unique identification, such as UDID, or UUID, a user agent, a current IP address, and in some cases a mobile device number and IMEI. In some cases, the server 101 may receive the mobile device unique identification information to identify the mobile device, and to determine whether the mobile application is already stored at the mobile device. The mobile device sends the server 101 the mobile device unique identification information and IP address, which is received by the server 101. Step 340 discloses storing the mobile device unique identification information and IP address in the mobile device database 120 of FIG. 1. In cases where the mobile device unique identification information of the mobile device is already stored in the mobile device database 120, the server 101 may use the unique identification information to validate the access of the mobile device. Step 345 discloses sending the mobile application to the mobile device. In some cases, the mobile device requires the mobile application to engage the retailer interface. The server sends the mobile application to the mobile device prior to sending the retail interface. Step 350 discloses sending the retailer interface to the mobile device by the server.

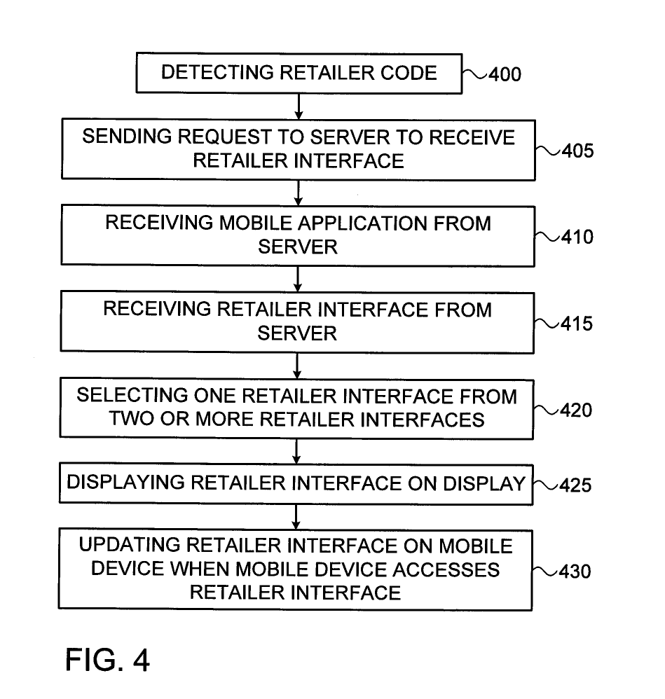

FIG. 4 shows a method performed on a mobile device for displaying a retailer interface, according to some exemplary embodiments of the subject matter. Step 400 discloses detecting a retailer code. The mobile device 140 of FIG. 1 detects the retailer code, for example by scanning a QR code available on a retailer website or retail store poster. Step 405 discloses sending a request to a server to receive the retailer interface. The mobile device 140 sends a request to the server 101 of FIG. 1 to receive the retailer interface that corresponds to the retailer code detected by the mobile device 140. Step 410 discloses receiving a mobile application from the server. In some cases, the mobile device 140 does not comprise the mobile application for engaging the retailer interface when the code of the retailer is detected. In that case the mobile device 140 is redirected by the server to receive the mobile application, which is embedded into the mobile device 140. Step 415 discloses receiving the retailer interface from the server. The mobile device 140 receives the retailer interface from the server 101. The retailer interface is stored in the retailer database 220 of FIG. 2. Step 420 discloses selecting one retailer interface from two or more retail interfaces. In some exemplary embodiments of the subject matter, the retailer may provide two or more retail interfaces. A user of the mobile device 140 may manually select the retailer interface that the user is interested in interacting. For example, the mobile device 140 receives two retailer interfaces for a clothing store, a first retailer interface for men's attire and a second retailer interface for women's attire. The user may manually select the second interface because the user is interested in women's clothing. Step 425 discloses displaying the retailer interface on a display interface 230 of FIG. 2. The display interface 230 showing the retailer interface enables the user to interact with the retailer interface. For example, the user may view products for sale, shop for products, and the like. The retailer interface may display sale coupons, and other modules that the retailer may provide to the user.

Step 430 discloses updating the retailer interface when the mobile device accesses the retailer interface. Where the retailer interface is selected by the user of the mobile device, the mobile device determines whether there is an update for the retailer interface, for example new discounts, products, change in layout, and the like. The mobile device 140 communicates with the server 101 requesting updates to the retailer interface. When there are updates the mobile device 140 receives the updates and updates the retailer interface so the retailer interface is displayed with updated information. For example, the user selects the retailer interface of a bookstore. The mobile device 140 requests updates from the server 101 for the retailer interface of the bookstore. The mobile device 140 receives an update of the retailer interface layout, which was changed from a blue logo of the bookstore to a red logo of the bookstore. The retailer interface is updated by the mobile device 140 and displayed on the display interface 230 with the red logo of the bookstore.

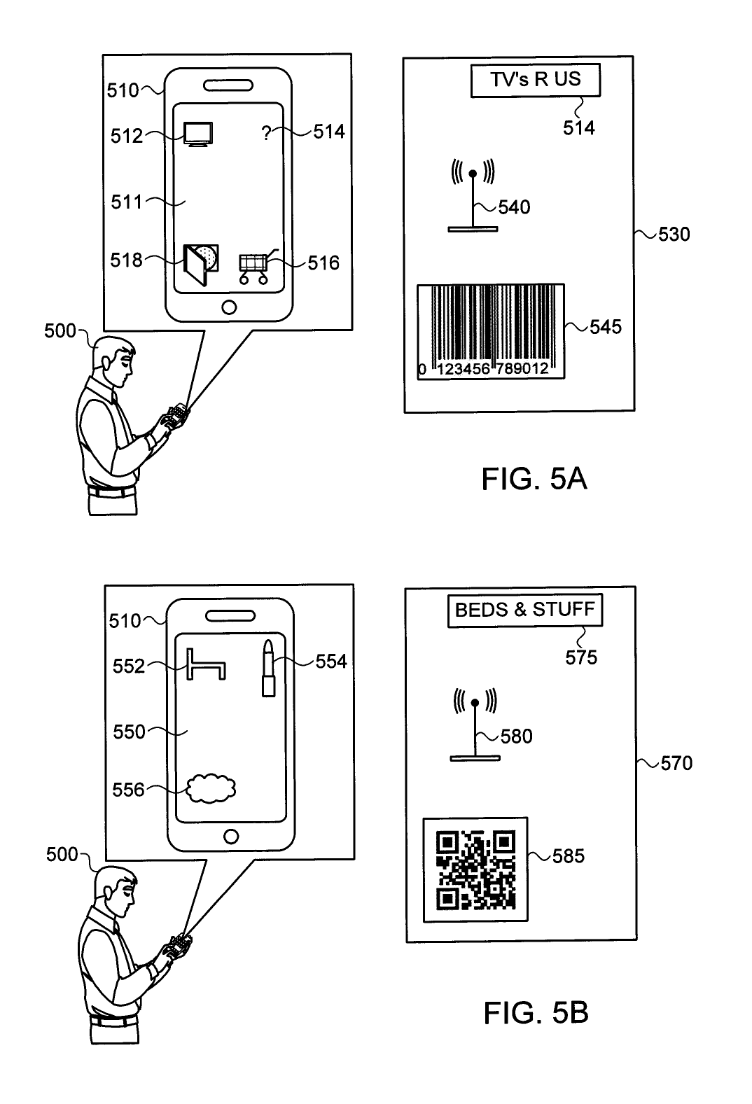

FIG. 5A shows a mobile device receiving a retailer code through wireless transfer, according to some exemplary embodiments of the subject matter. A user 500 carries a mobile device 510, which the user 500 uses to receive the retailer code. The mobile device 510 may receive the retailer code from a wireless connection 540 associated with the retailer. The mobile device 510 may receive the retailer interface through a wireless connection 540, which is communicated by a retailer 530. In some cases, the user 500 may be carrying the mobile device 510 inside a physical location of the retailer 530 so that when the mobile device 510 is within an area of coverage of the wireless connection 540, the mobile device obtains a retail code for obtaining the retailer interface. For example, the user 500 walks near a retailer 530 named TV's R Us. When the user 500 enters the area of coverage of the wireless connection 540 associated with the retailer 530 named TV's R Us, the mobile device 510 receives the retailer code. The user 500 enters the retailer code to obtain the retailer interface. When the retailer interface is engaged on the mobile device 510, a display interface 511 shows the retailer interface with icons, such as a television icon 512, a question mark icon 514, a shopping cart icon 516 and DVD's icon 518. In some exemplary embodiments of the subject matter, the user 500 may use the mobile device 510 to scan a barcode 545, which may be located on the retailer, to obtain the retailer code. In some exemplary embodiments of the subject matter, the user 500 may obtain the retailer code by obtaining an image of a retailer logo 535 with the mobile device 510. For example, the user 500 obtains an image of the retailer logo 535 titled Tv's R Us using the mobile device 510. The mobile device 510 sends the image of the logo 535 to the server 101 of FIG. 1 to receive the retailer code.

FIG. 5B shows a mobile device receiving a retailer code through a QR scanning, according to some exemplary embodiments of the subject matter. The user 500 uses the mobile device 510 to scan a QR code 585 to obtain the retailer interface. For example, the user 500 scans the QR code 585 located on a poster of Beds & Stuff 575. The mobile device 510 obtains the retailer code from the QR code 585 and requests the retailer interface. The mobile device 510 receives the retailer interface which may comprise, for example, a bed icon 552, a lipstick icon 554, a brush icon 556, and the like. The user may now interact with the retailer icon displayed on a display interface 550.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method performed on a server, comprising:
receiving a retailer interface information from a retailer, said retailer interface information comprises features selection information and layout selection information of the retailer;
generating a retailer interface from the retailer interface information;
detecting an event between a mobile device and the retailer;
responsive to detection of the event, receiving a request to download the retailer interface to be embedded in a mobile application of the mobile device;
transmitting the retailer interface to the mobile device.

2. The method of claim 1, wherein the event is the mobile device receiving a retailer code of the retailer.

3. The method of claim 1, wherein the request is sent upon detection of a retailer code.

4. The method of claim 1, wherein a retailer code is generated by the server and sent to the retailer.

5. The method of claim 1, further comprises sending the mobile application to the mobile device for displaying the retailer interface.

6. The method of claim 5, wherein the mobile application is a same binary application.

7. The method of claim 6, wherein the same binary application comprises a different icon, a name, a description on the server according to parameters sent to the server through a download link and a combination thereof.

8. The method of claim 1, further comprises the retailer interface updating when a mobile device accesses the retailer interface.

9. The method of claim 1, further comprises generating two or more retailer codes for the retailer, each retailer code of the two or more retailer codes is provided to a different mobile device.

10. The method of claim 1, further comprises generating two or more retailer codes for the retailer, at least two retailer codes of the two or more retailer codes are associated with different retailer interfaces.

11. The method of claim 1, wherein the features selection information comprises modules that are configured to be activated by the mobile device.

12. The method of claim 1, further comprises storing a mobile device unique identification information and a IP address to identify the mobile device by the server.

13. The method of claim 1, further comprises transmitting a download link to the retailer, wherein the download link is provided for the mobile device to access the retailer interface.

14. A method performed on a mobile device, comprising:
detecting a retailer code associated with a retailer;
sending a request to a server to receive a retailer interface, said retailer interface corresponding to the retailer code;
receiving the retailer interface from the server;
displaying the retailer interface on the mobile device.

15. The method of claim 14, further comprises receiving a mobile application to engage the retailer interface.

16. The method of claim 15, wherein the mobile application is configured to provides the mobile device with content associated with a plurality of retailers, wherein the content is associated with the retailer of the plurality of retailers according to the retailer code.

17. The method of claim 16, wherein the mobile application serves the plurality of retailers by providing the mobile device the content associated with the plurality of retailers according to data received from the server, wherein the mobile application displays the content associated with a single retailer of the plurality of retailers according to the retailer code.

18. The method of claim 14, wherein detecting the retailer code comprises obtaining an image of a retailer logo.

19. The method of claim 14, wherein detecting the retailer code comprises scanning a retailer QR code.

20. The method of claim 14, further comprises selecting one retailer interface from two or more retailer interfaces.
